(19) United States
(12) Patent Application Publication
(10) Pub. No.: US 2026/0360956 A1
(43) Pub. Date: Nov. 12, 2026

(54) POTTING DAMS FOR A BATTERY PACK

(71) Applicant: Rivian IP Holdings, LLC, Irvine, CA (US)

(72) Inventors: Vinay Vilas JADHAV, Fremont, CA (US); Nick TEOH, Irvine, CA (US); Karteek PALLERLA, Irvine, CA (US); Suraj SHROFF, San Francisco, CA (US); Stephen Douglas RAY, Downers Grove, IL (US); Tyler Joseph BLASE, Normal, IL (US)

(21) Appl. No.: 19/204,378

(22) Filed: May 9, 2025

(51) Int. Cl. H01M 50/588; B60L 50/64; H01M 50/209; H01M 50/211; H01M 50/213; H01M 50/249; H01M 50/271

(52) U.S. Cl. CPC H01M 50/588; B60L 50/64; H01M 50/209; H01M 50/211; H01M 50/213; H01M 50/249; H01M 50/271; H01M 2220/20

(57) ABSTRACT

Battery packs may include potting dams to direct or limit the flow of a potting material. Some potting dams may be compressed by one or more components, thereby forming a seal based on the compression. Some potting dams may include a dispensed hot melt material disposed between two components such that when cured prevents a flow of potting material between the components.

### INTRODUCTION

Batteries are often used as a source of power, including as a source of power for electric vehicles that include wheels that are driven by an electric motor that receives power from the batteries. A battery may include several battery cells carried within a module and/or a carrier.

### SUMMARY

The subject technology is directed to potting dams used in battery packs. The potting dams may be used to limit the flow of a potting materials dispensed in a battery pack.

In one or more aspects of the present disclosure, a potting dam is disclosed. The potting dam may include a body. The body may include a first dimension configured to extend to at least a first end of a frame and to at least a second end of the frame opposite the first end. The body may further include a second dimension less than the first dimension. In response to a compression force, the body is configured to compress and provide a seal against a flow of a potting material in a direction along the second dimension.

The body of the potting dam may further include a first cut out portion configured to provide a first space for a first terminal. The body of the potting dam may further include a second cut out portion configured to provide a second space for a first terminal. Based on the first cut out portion, the body may be further configured to provide a seal against the flow of the potting material in a direction along the first dimension.

The body may define a first connection point to a cover configured to cover battery cells, the first connection point being external to the first cut out portion and the second cut out portion. The body may further define a second connection point to the cover, the second connection point being external to the first cut out portion and the second cut out portion. The body may further define a third connection point to the cover, the third connection point being between the first cut out portion and the second cut out portion.

The first dimension may be perpendicular with respect to the second dimension. Also, the body may include a foam. The foam includes an open cell foam.

In one or more aspects of the present disclosure, a battery pack is disclosed. The battery pack may include a plurality of battery cells electrically coupled together via a current collector assembly. The battery pack may further include a frame configured to cover at least a portion of the current collector assembly, the frame defining a lip. The battery pack may further include a lid configured to receive at least the plurality of battery cells. The battery pack may further include a first potting dam. In response to the first potting dam being compressed between the lip and the lid, the first potting dam may be configured to compress and provide a seal to maintain a potting material between the plurality of battery cells.

The battery pack may further include a cover configured to overlay the plurality of battery cells. The first potting dam may be coupled with the cover. The battery pack may further include a second potting dam. The first potting dam may be located at a first end of the cover. Also, the second potting dam may be located at a second end of the cover. The second end may be opposite the first end. The second potting dam may extend from the cover and may be compressed between the lid and the lip. The second potting dam may include a first cut out portion configured to provide a first space for a first terminal. The second potting dam may further include a second cut out portion configured to provide a second space for a first terminal.

The second potting dam may define a first connection point to the cover external to the first cut out portion and the second cut out portion. The second potting dam may further define a second connection point to the cover external to the first cut out portion and the second cut out portion. The second potting dam may further define a third connection point to the cover between the first cut out portion and the second cut out portion.

The battery pack further include a bar that extends along the plurality of battery cells. The battery pack further include a third potting dam including a hot melt material disposed in a gap between a module that carries the plurality of battery cells and the bar. The first potting dam, the second potting dam, and the third potting dam may combine to confine the potting material between the plurality of battery cells. Each of the first potting dam and the second potting dam may include a foam.

In one or more aspects of the present disclosure, a vehicle is disclosed. The vehicle may include one or more electric motors. The vehicle may further include a battery pack configured to provide power for the one or more electric motors. The battery pack may include a plurality of battery cells electrically coupled together via a current collector assembly. The battery pack may further include a frame configured to cover at least the current collector assembly, the frame defining a lip. The battery pack may include a cover configured to overlay the plurality of battery cells. The battery pack may include a lid configured to receive at least the plurality of battery cells. The battery pack may include a first potting dam coupled with a first end of the cover. The battery pack may include a second potting dam coupled with a second end of the cover opposite the first end. In response to the first potting dam and the second potting dam being compressed between the lip and the lid, the first potting dam and the second potting dam are configured to compress and provide respective seals to maintain a potting material between the plurality of battery cells.

The first potting dam may extend from the cover. The second potting dam may include a first cut out portion configured to provide a first space for a first terminal. The second potting dam may further include a second cut out portion configured to provide a second space for a first terminal.

The second potting dam may define a first connection point to the cover external to the first cut out portion and the second cut out portion. The second potting dam may further define a second connection point to the cover external to the first cut out portion and the second cut out portion. The second potting dam may further define a third connection point to the cover between the first cut out portion and the second cut out portion.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates an exploded perspective view of a battery module, in accordance with one or more implementations of the present disclosure.

FIGS. 4 and FIG. 5 illustrate aerial views of examples of potting dams, in accordance with one or more implementations of the present disclosure.

FIGS. 6 and FIG. 7 illustrate perspective views of examples of potting dams and a cover, in accordance with one or more implementations of the present disclosure.

FIGS. 8A, FIG. 8B, and FIG. 9, illustrate partial cross sectional views of a battery pack, showing a potting dam functioning as a seal, in accordance with one or more implementations of the present disclosure.

FIGS. 10 and FIG. 11 illustrate aerial views of potting dams forming a seal, in accordance with one or more implementations of the present disclosure.

FIG. 12 illustrates an aerial view of a battery pack, showing locations of additional potting dams, in accordance with one or more implementations of the present disclosure.

FIG. 13 illustrates a cross sectional view of the battery pack shown in FIG. 12, further showing a potting dam between a battery module and a bar, in accordance with one or more implementations of the present disclosure.

FIG. 14 illustrates a flow diagram showing a process for providing a potting material to a battery pack, in accordance with implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to potting dams used to direct, limit, and/or prevent the flow of a potting material in a battery pack or a battery module of the battery pack. Some potting dams are located at the front and rear of the battery pack, and include a foam-based material. These potting dams are designed to compress (e.g., between a cover for battery cells and a lid) and form a seal based in part on the compression. Other potting dams include a dispense hot melt potting dam that can be positioned between vertical surfaces, such as between a battery module and a longitudinal wall, or longitudinal bar. The potting dams form potting seals to minimize or prevent potting leaks during a potting material dispense operation. By minimizing or preventing potting leaks, the correct volume (to within a threshold volume) of potting materials cures within an energy volume (e.g., between and around battery cells of the battery pack). Moreover, minimized potting leaks may lead to cost savings as well as maintaining an open volume or space (e.g., where no potting material flows) such that a battery pack may consolidated, due to the open space, during an impact event.

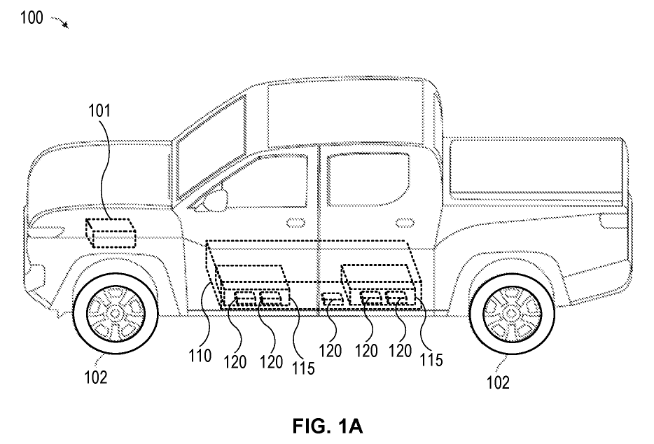

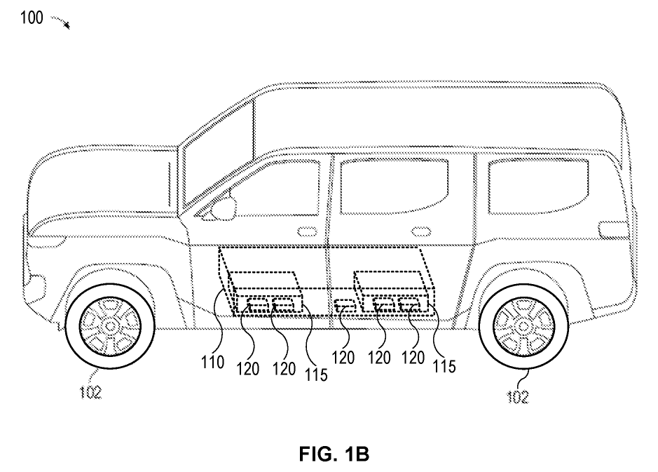

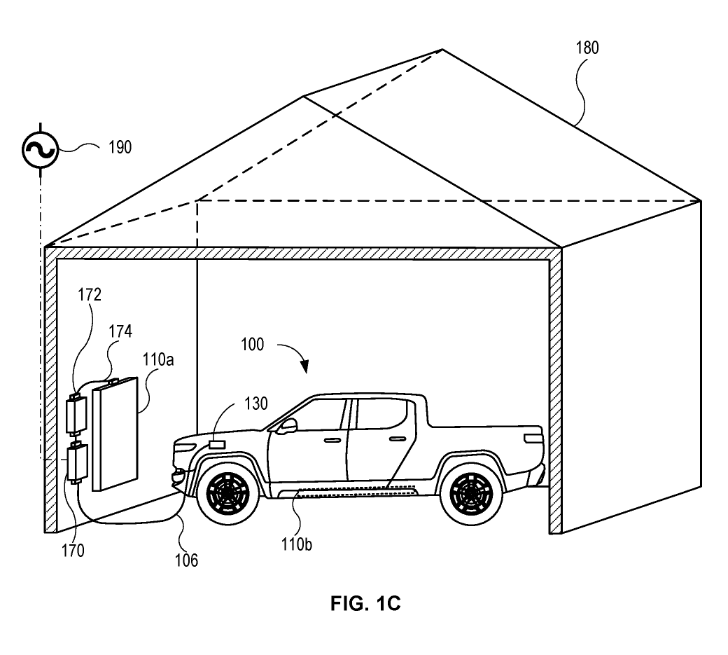

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors 101 that drive the wheels 102 of the vehicle 100 using electric power from the battery pack 110. The one or more electrical motors 101 may include a propulsion component. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

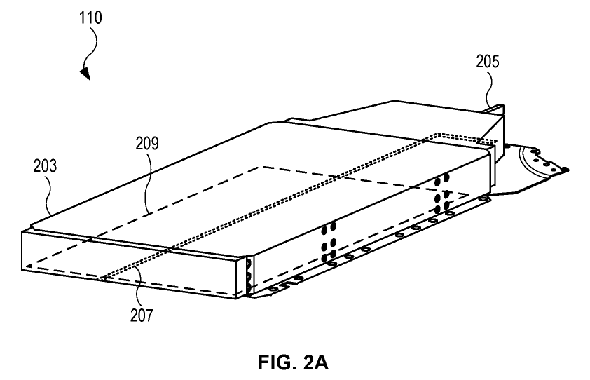

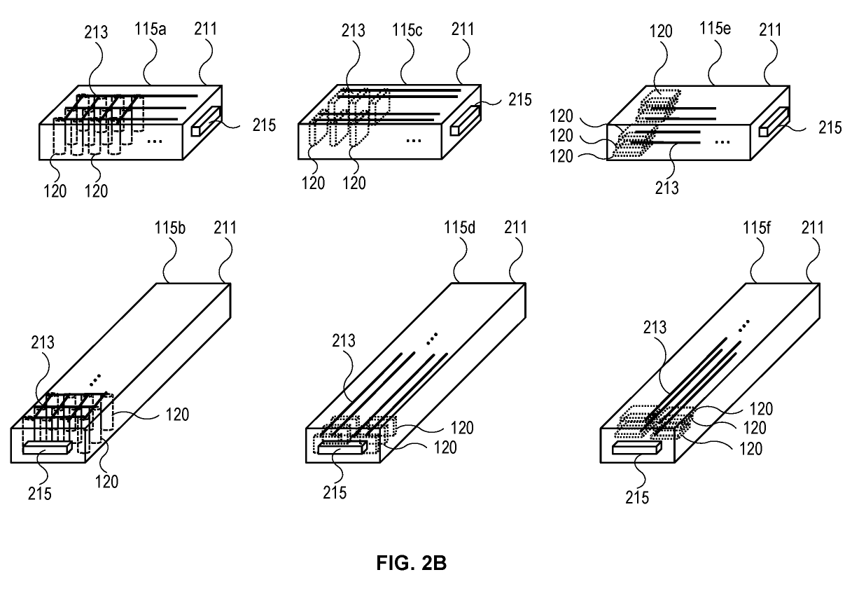

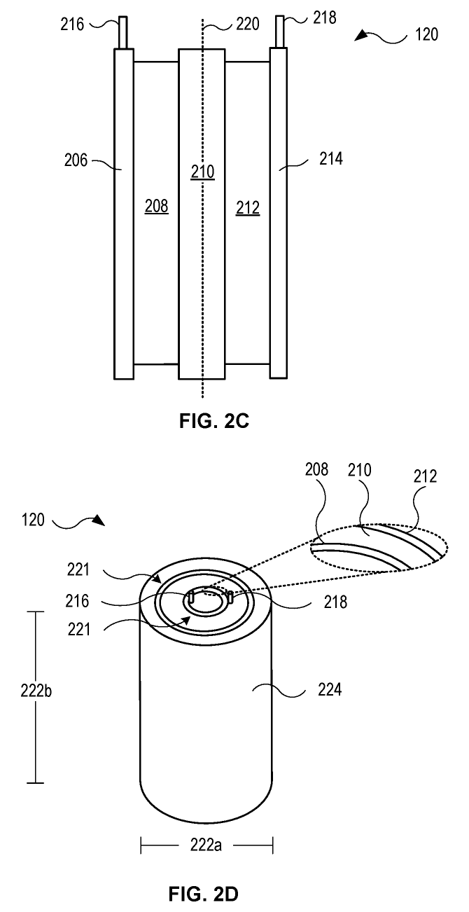

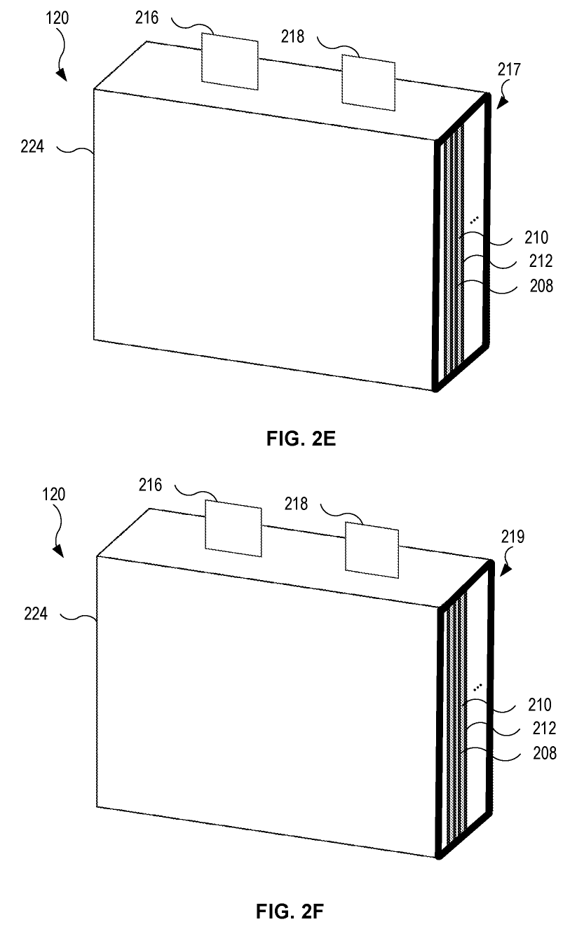

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

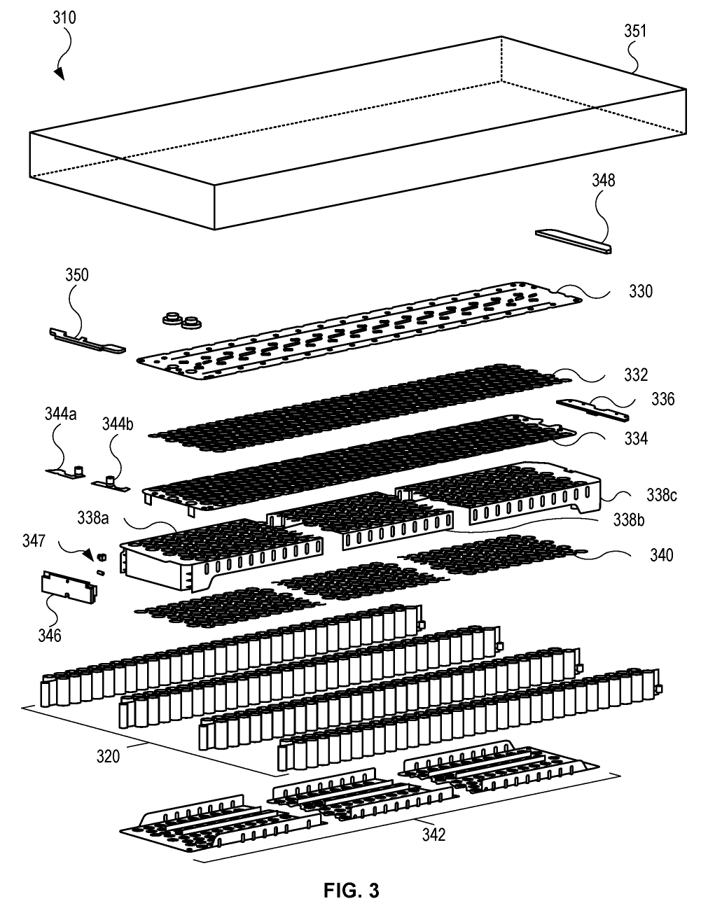

FIG. 3 illustrates a perspective exploded view of a battery pack 310, in accordance with one or more implementations of the present disclosure. The battery pack 310 may include a cover 330, encapsulants 332, a CCA 334, a busbar 336, a frame 338a, a frame 338b, a frame 338c, a separation layers 340 (representative of one or more separation layers), battery cells 320, and a base 342. One or more battery modules of the battery pack 310 may be shown and described in FIG. 3. Alternatively, in one or more implementations, the battery pack 310 does not include battery modules, i.e., the battery pack 310 may not be modularized into separate battery modules.

The cover 330 may be disposed on a top of the battery pack 310. Accordingly, the cover 330 may be referred to as a top cover configured to overlay the battery cells 320. The base 342 may be disposed on a bottom of the battery pack 310. The base 342 can be provided as multiple pieces (as shown in FIG. 3) or as one piece. The battery cells 320 may be inserted as one or more sets into a crate structure formed by the base 342. Further, the battery cells 320 may be positioned on opposing sides of a center beam (not shown) and/or within sidewalls of the base 342.

In one or more implementations, each of the frames 338a, 338b and/or 338c takes the form of a monolithic unitary body (e.g., a molded body formed from plastic and/or other materials) and may include a top portion and/or sidewalls. As shown in FIG. 3, the frames 338a, 338b, and 338c are multiple frame pieces (e.g., separate bodies). Also, each of the frames 338a, 338b and/or 338c may extend across at least a portion of each of the battery cells 320. The frames 338a, 338b, 338c may be joined together when secured to the battery cells 320. Where the frames 338a, 338b, 338care provided as multiple frame pieces, two of the frames 338a, 338b, 338c may form end portions of a joined structure, and one or more additional frames can form a midportion of the joined structure. As such, any configuration, number, and/or length of the battery cells 320 may be engaged by a selection of a corresponding set of frames. Furthermore, the frames 338a, 338b, and 338c can be secured to one or more sets of the battery cells 320 to be secured relative to each other along the lengths of the set(s) of the battery cells 320.

When the battery pack 310 is assembled, the CCA 334 may take the form of an apparatus that connects the respective terminals (e.g., positive and negative terminals) of the battery cells 320 to one or more of a busbar 344a or a busbar 344b. Several busbars may be integrated. For example, the busbar 344a (e.g., a positive busbar) may electrically couple to respective first terminals (e.g., the positive terminals) of the battery cells of the battery pack 310, and the busbar 344b (e.g., a negative busbar) may electrically couple to respective second terminals (e.g., the negative terminals) of the battery cells 320. As further shown in FIG. 3, a busbar 336 (e.g., series busbar for electrically connect at least some of the battery cells 320 in series) may also be provided (e.g., on an opposing end of the frames 338a, 338b and/or 338c from the end of the respective cell carriers at which the busbars 344a and 344b are mounted). The CCA 334 may be carried by a frame (e.g., CCA frame), which will be shown and described below.

As further shown in FIG. 3, the encapsulants 332 may be provided, with an encapsulant of the encapsulants 332 positioned between the cover 330 and a corresponding battery cell of the battery cells 320. The encapsulants 332 may surround a region at which the CCA 334 connects to the terminals of the battery cells 320. The encapsulants 332 may further extend to cover and/or contact portions of the frames 338a, 338b, and/or 338c.

The busbar 336 may be provided to connect the sets of the battery cells 320 to each other. The busbar may be provided on top of one or more of the frames 338a, 338b, and/or 338c. In one or more implementations, the busbar 336 is provided in a same plane that is occupied by the CCA 334 and/or the encapsulants 332.

In one or more implementations, a balancing voltage and temperature (BVT) module 346 communicatively couples to a thermistor assembly 347. The BVT module 346 may take the form a modular assembly of various electrical components to monitor or control components of the battery pack 310. For example, the BVT module 346 may include a circuit board that is attached to a housing of the BVT module 346. The BVT module 346 may include various connectors to couple with, for example, the thermistor assembly 347, a voltage sensor, and/or a communication device, as non-limiting examples. The thermistor assembly 347 may measure a temperature of the battery pack 310 and/or one or more of the battery cells 320. The voltage sensor (not shown in FIG. 3), or balancer, may sense or control voltage that flows through the battery pack 310 and/or one or more of the battery cells 320. The communication device (not shown in FIG. 3) may receive, transmit, or analyze data associated with the battery pack 310 and/or one or more of the battery cells 320.

Additionally, the battery pack 310 may include a potting dam 348 and a potting dam 350. The potting dams 348 and 350 are designed prevent, restrict, or otherwise limit the flow of a potting material (not shown in FIG. 3). In this regard, the potting dams 348 and 350 may form a seal that limits the flow of the potting material. This will be shown and described in further detail below.

The battery pack 310 may be loaded into a lid 351. The lid 351 may define an internal volume, or space, for the aforementioned components of the battery pack 310.

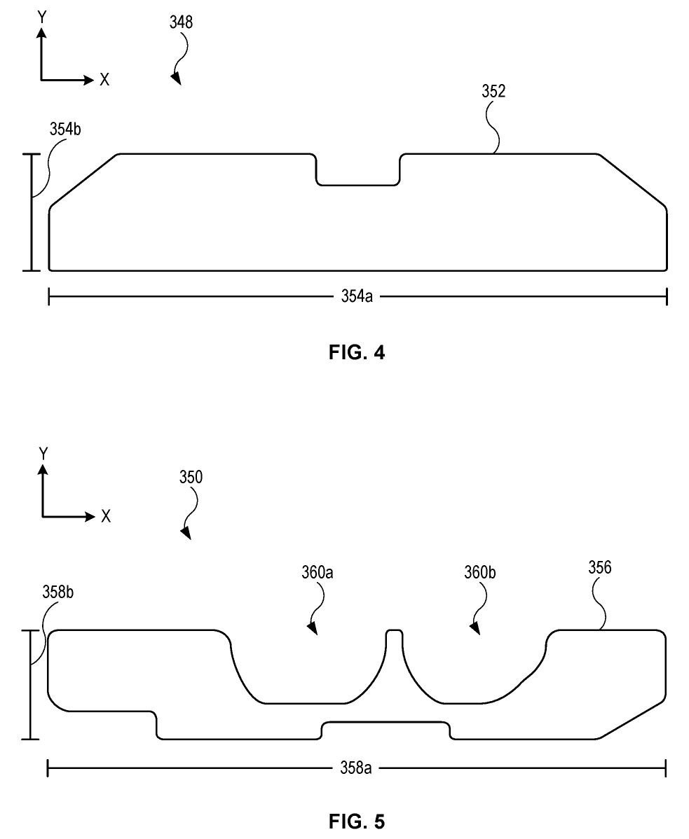

FIGS. 4 and FIG. 5 illustrate aerial views of examples of potting dams, in accordance with one or more implementations of the present disclosure. The potting dams 348 and 350 shown in FIGS. 4 and 5, respectively, may take the form of a compressible body designed to form a seal when compressed. The potting dams 348 and 350 may be positioned at different locations of a battery pack (e.g., battery pack 310 shown in FIG. 3). For example, the potting dam 348 and the potting dam 350 may be located at a front and at a rear, respectively, of a battery pack, or the front and the back respectively, of a battery module(s) of a battery pack. In one or more implementations, each of the potting dams 348 and 350 takes the form of a foam, which may include an open cell foam or a closed cell foam (as non-limiting examples). However, each of the potting dams 348 and 350 may take the form of other compressible, non-foam materials.

Referring to FIG. 4, the potting dam 348 may include a body 352. As shown, the body 352 includes a dimension 354a (e.g., width, taken along the X axis of Cartesian coordinates) and a dimension 354b (e.g., height, taken along the Y axis of Cartesian coordinates). Accordingly, the dimension 354a is perpendicular with respect to the dimension 354b, and vice versa. As shown, the dimension 354a is greater than the dimension 354b, or conversely, the dimension 354b is less than the dimension 354a. The body 352 may be integrated with a battery pack (e.g., battery pack 310 shown in FIG. 3) such that, when compressed, the body 352 provides a seal against ingress from a material(s), such as a potting material that is filled/provided between battery cells (e.g., battery cells 320 shown in FIG. 3). In particular, the body 352, when compressed may provide the seal against flow from a potting material along the dimension 354b (e.g., along the Y axis). This will be shown and described below.

Referring to FIG. 5, the potting dam 350 may include a body 356. As shown, the body 356 includes a dimension 358a (e.g., width, taken along the X axis of Cartesian coordinates) and a dimension 358b (e.g., height, taken along the Y axis of Cartesian coordinates). Accordingly, the dimension 358a is perpendicular with respect to the dimension 358b, and vice versa. As shown, the dimension 358a is greater than the dimension 358b, or conversely, the dimension 358b is less than the dimension 358a. The body 356 may be integrated with a battery pack (e.g., battery pack 310 shown in FIG. 3) such that, when compressed, the body 356 provides a seal against ingress from a material(s), such as a potting material that is filled/provided between battery cells (e.g., battery cells 320 shown in FIG. 3). In particular, the body 356, when compressed may provide the seal against flow from a potting material along the dimension 358b (e.g., along the Y axis). This will be shown and described below.

Additionally, the body 356 may further include cut out portion 360a and a cut out portion 360b. Each of the cut out portions 360a and 360b may accommodate (e.g., provide space for) a respective battery cells of battery cells (e.g. two battery cells of the battery cells 320 shown in FIG. 3). Based on the cut out portions 360a and 360b, a material (e.g., potting material) may be dispensed into regions or voids corresponding to the cut out portions 360a and 360b. In this regard, a potting material that flows into one or more of the cut out portion 360a or the cut out portion 360b may be limited or prevented in movement by the body 356 in not only along the dimension 358b (e.g., along the Y axis) but also along the dimension 358a (e.g., along the X axis).

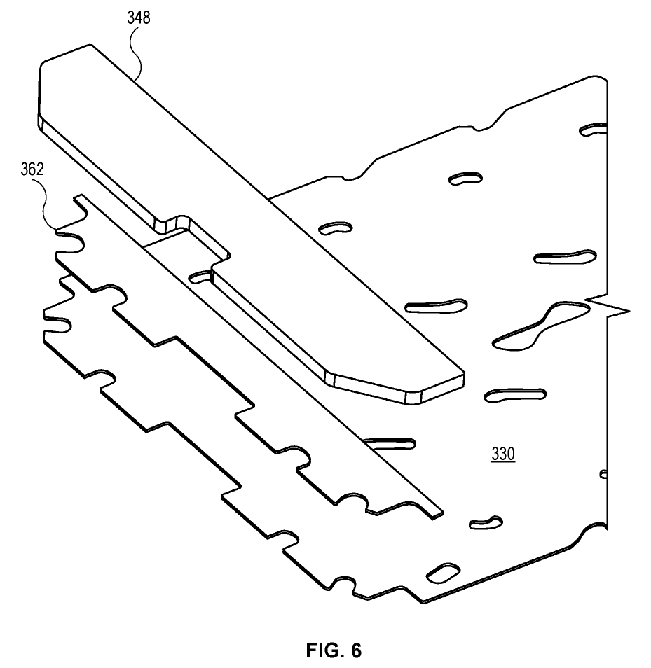

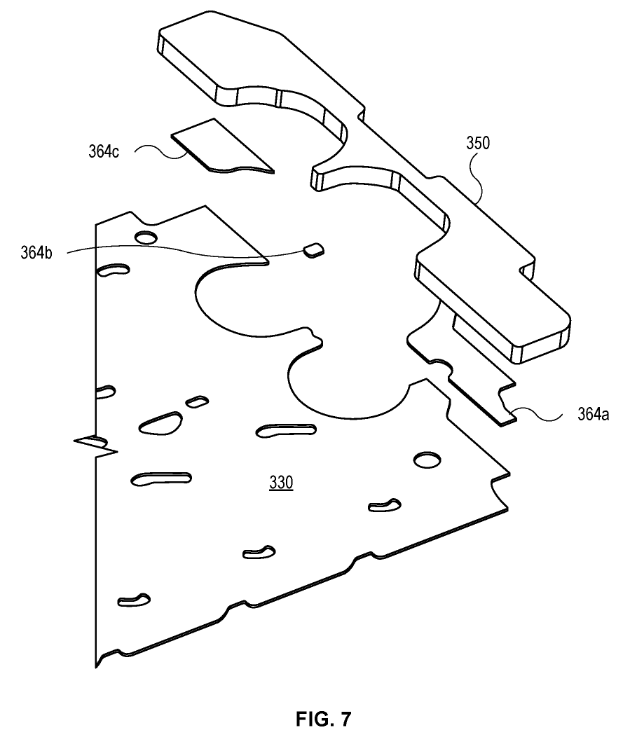

FIG. 6 and FIG. 7 illustrate perspective views of examples of potting dams and a cover 330, in accordance with one or more implementations of the present disclosure. Referring to FIG. 6, the potting dam 348 may be coupled with the cover 330 by an adhesive layer 362. In one or more implementations, the adhesive layer 362 takes the form of a pressure sensitive adhesive layer (PSA). In this regard, the adhesive layer 362 may form a bond between the cover 330 and the potting dam 348 via, for example, a force (e.g., compression force) applied to the potting dam 348. Accordingly, the adhesive layer 362 may provide a connection point between the cover 330 and the potting dam 348.

Referring to FIG. 7, the potting dam 350 may be coupled with the cover 330 by an adhesive layer 364a, an adhesive layer 364b, and an adhesive layer 364c. In one or more implementations, each of the adhesive layers 364a, 364b, and 364c takes the form of PSA. In this regard, the adhesive layers 364a, 364b, and 364c may each form a bond between the cover 330 and the potting dam 350 via, for example, a force (e.g., compression force) applied to the potting dam 350. Accordingly, the adhesive layers 364a, 364b, and 364c may provide respective connection points between the cover 330 and the potting dam 350.

The adhesives layer 362 (shown in FIG. 6) and the adhesive layers 364a, 364b, and 364c (shown in FIG. 7) are designed to maintain the potting dams 348 and 350, respectively, in place. The aforementioned adhesive layers may prevent movement of the aforementioned potting dams due to, for example, hydrostatic pressure from a potting material.

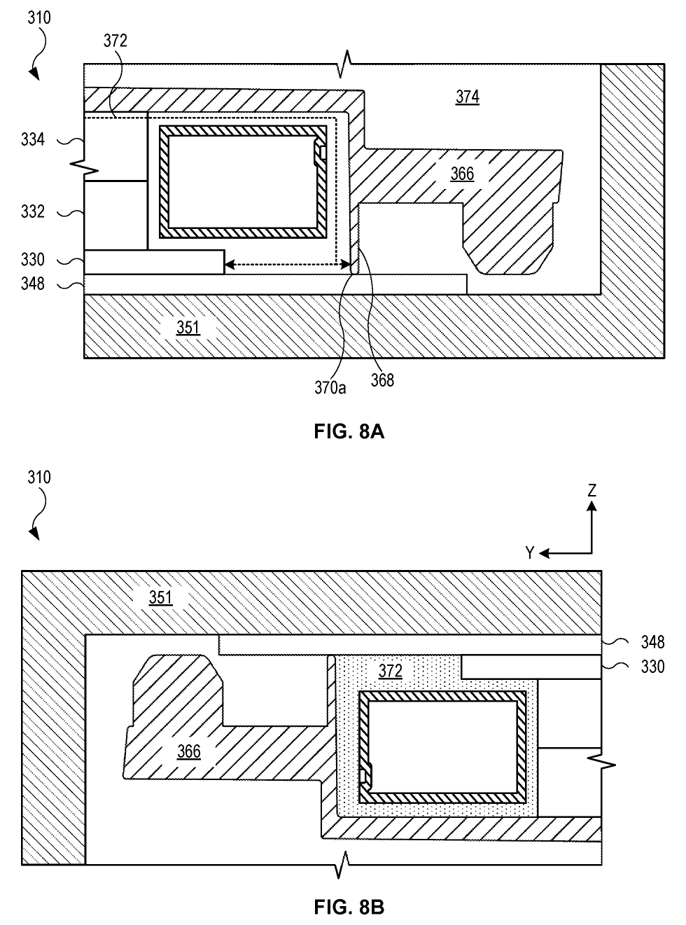

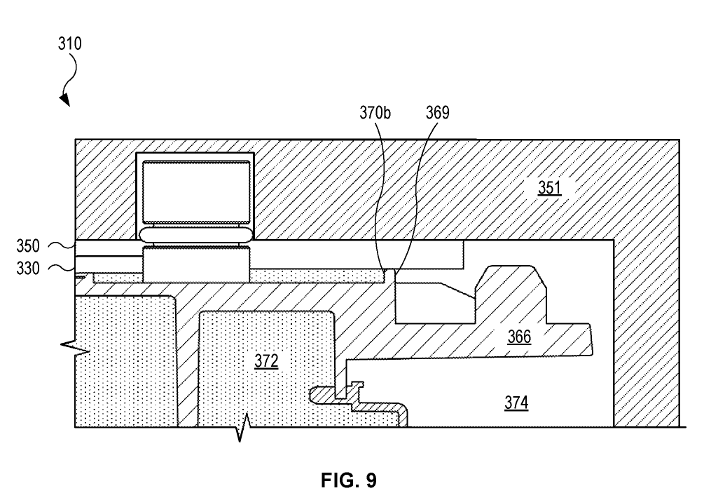

FIGS. 8A, FIG. 8B, and FIG. 9 illustrate partial cross sectional views of a battery pack 310, showing a potting dam functioning as a seal, in accordance with one or more implementations of the present disclosure. Referring to FIG. 8A, the lid 351 may be rotated (e.g., rotated 180 degrees) relative to the position of the lid 351 shown in FIG. 3. As a result, several components may be inserted into the lid 351. For example, the CCA 334, the encapsulants 332, the cover 330, and the potting dam 348 are disposed (e.g., positioned) in the lid 351. As shown, the potting dam 348 may interface with the cover 330 and the lid 351. Additionally, a frame 366 is shown and is utilized to provide support for the CCA 334. In this regard, the frame 366 may be referred to as a CCA frame that covers, or at least partially covers a portion of, the CCA 334. The frame 366 may include a material, such as plastic (as a non-limiting example) or other non-metal material(s). As shown, the frame 366 includes a lip 368 that is engaged with the potting dam 348.

Based on its position between the cover 330 and the lid 351, the potting dam 348 may be compressed (e.g., due to external forces provided by the cover 330 and/or the lid 351). In one or more implementations, the potting dam 348 is compressed by 80%. Put another way, the potting dam 348, when compressed, may be reduced to 20% of its original volume. Additionally, the potting dam 348 is positioned between the lip 368 and the lid 351 and may be compressed (e.g., due to external forces provided by the lip 368 and/or the lid 351). In this regard, the potting material 348 may extend beyond the lip 368 so as to ensure contact/engagement with the lip 368. When compressed between the lip 368 and the lid 351, the potting dam 348 may form a seal 370a. When a potting material 372 (represented as dotted lines) is dispensed in liquid form into the battery pack 310, the seal 370a, formed in part by the compression of the potting dam 348, provides a barrier that limits, or at least partially limits, the flow of the potting material 372. Moreover, the potting material 372 may be redirected by the potting dam 348 to flow between the battery cells 320 (shown in FIG. 3). Based on the potting dam 348, the potting material 372 may not flow into a space 374 (defined in part by the lid 351 and frame 366) where the potting material 372 could otherwise flow externally with respect to the lid 351.

Referring to FIG. 8B, when the potting material 372 cures (e.g., from liquid to solid form), the battery pack 310 may be rotated. As shown, the battery pack 300 is rotated 180 degrees relative to FIG. 8A. As a result, the lid 351 is positioned over (e.g., elevated with respect to the Z axis) the potting dam 348, the cover 330, the encapsulants 332, the CCA 334, and the frame 366. Based in part on the potting dam 348, the potting material 372 is confined, or at least partially confined. Also, the potting dam 348 may extend laterally (e.g., along the Y axis) beyond the cover 330.

Referring to FIG. 9, the potting dam 350 may also be compressed by the lid 351 and/or the frame 366 in manner similar to that of the potting dam 348 (shown in FIG. 8A). As shown, the frame 366 may further include a lip 369. When compressed, the potting dam 350 may provide a seal 370b, based in part on the potting dam 350 and the lip 369, to prevent the potting material 372, in a liquid state, from extending into the space 374. In this regard, the potting material 350 may extend beyond the lip 369 so as to ensure contact/engagement with the lip 369. As shown in FIG. 9, the potting material 372 is cured. Also, the potting dam 350 may interface with the cover 330 and the lid 351. Once the potting material 372 is cured, the battery pack 310 may be rotated to the position shown in FIG. 9. Accordingly, the potting dam 348 (shown in FIG. 8A) and the potting dam 350 may combine to confine the potting material 372. In one or more implementations, the potting dams 348 and 350 combine to confine the potting material 372 to a location between the battery cells 320 (shown in FIG. 3).

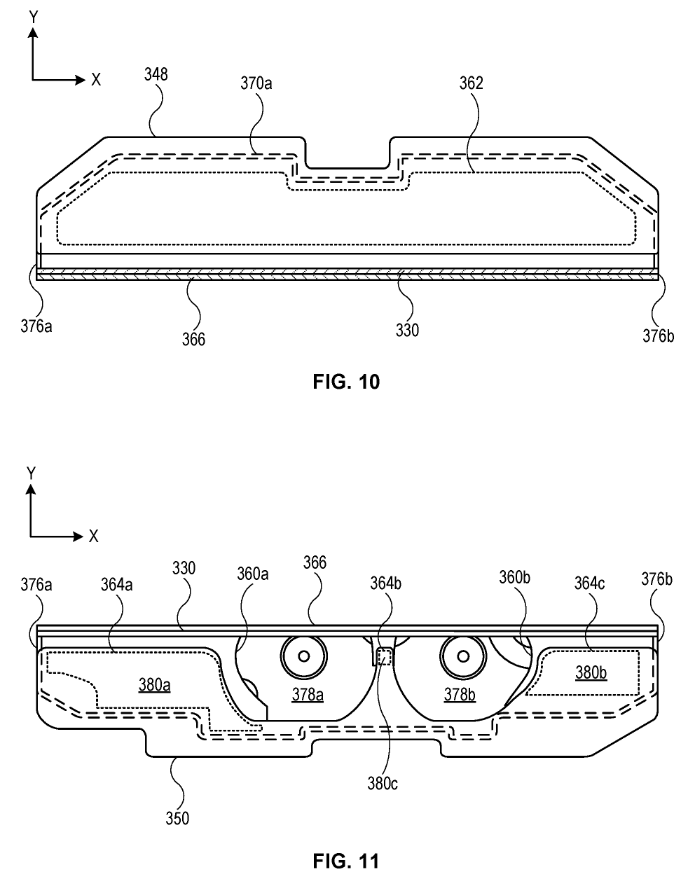

FIGS. 10 and FIG. 11 illustrate aerial views of potting dams forming a seal, in accordance with one or more implementations of the present disclosure. Referring to FIG. 10, the potting dam 348 (e.g., the body 352 of the potting dam 348 shown in FIG. 4) may extend laterally (e.g., along the X axis) from at least an end 376a of the frame 366 to an end 376b of the frame 366, with the end 376a being opposite the end 376b, and vice versa. Further, the potting dam 348 (e.g., the body 352 of the potting dam 348 shown in FIG. 4) may extend beyond the frame 366 in order to form the seal 370a with the lip 368 (shown in FIG. 8A). The seal 370a, formed in part by the potting dam 348, may be a multi-dimensional seal extending along the X and Y axes, as shown in FIG. 10. Also, based in part on the adhesive layer 362, the potting dam 348 may define a connection point between the potting dam 348 and the cover 330.

Referring to FIG. 11, the potting dam 350 (e.g., the body 356 of the potting dam 350 shown in FIG. 5) may extend laterally (e.g., along the X axis) from at least the end 376a of the frame 366 to the end 376b of the frame 366. The seal 370b, formed in part by the potting dam 350, may be a multi-dimensional seal extending along the X and Y axes, as shown in FIG. 11. Additionally, the cut out portion 360a and the cut out portion 360b of the potting dam 350 provide a space for a battery cell 378a and a battery cell 378b, respectively, of the battery cells 320 (shown in FIG. 3) in order for the battery cell 378a and the battery cell 378b to make a connection (e.g., electrical connection) with the busbar 344a and the busbar 344b (shown in FIG. 3), respectively. Also, based in part on each of the adhesive layer 364a, the adhesive layer 364b, and the adhesive layer 364c, the potting dam 350 may define respective connection points between the potting dam 350 and the frame 366. As shown, the potting dam 350 (e.g., the body 356) defines a connection point 380a to the cover 330, with the connection point 380a being external to the cutout portion 360a and the cutout portion 360b. Similarly, the potting dam 350 (e.g., the body 356) further defines a connection point 380b to the cover 330, with the connection point 380b being external to the cutout portion 360a and the cutout portion 360b. Also, the potting dam 350 (e.g., the body 356) further defines a connection point 380c to the cover 330, with the connection point 380c being between the cutout portion 360a and the cutout portion 360b.

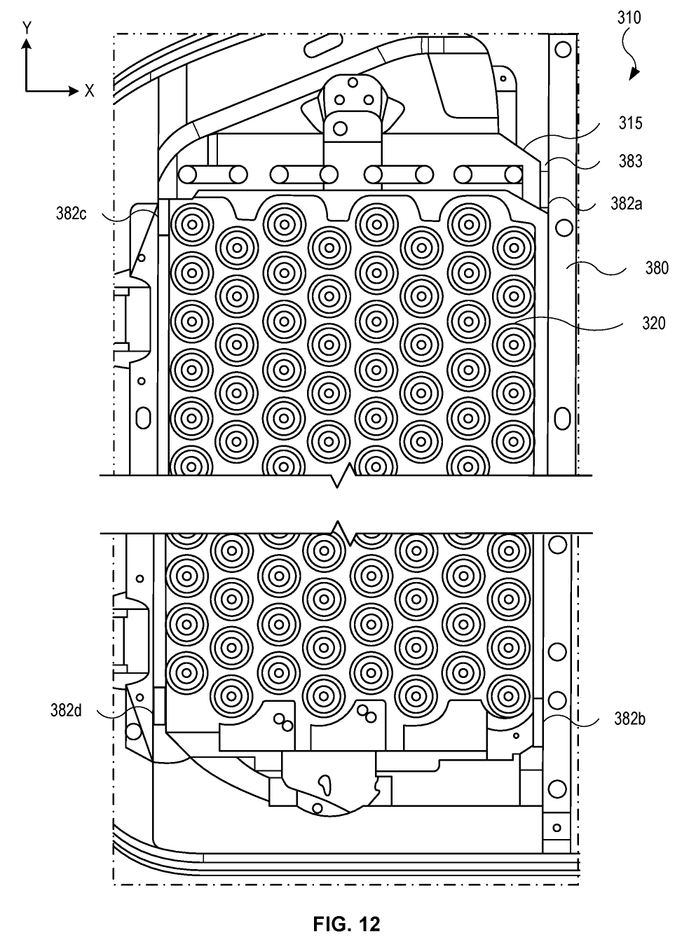

FIG. 12 illustrates an aerial view of the battery pack 310, showing locations of additional potting dams, in accordance with one or more implementations of the present disclosure. As shown, a bar 380 may extend longitudinally along the battery pack 310, including along the battery cells 320. The bar 380 may be part of the lid 351 (shown in FIG. 3), or alternatively, part of the battery pack 310. A potting dam 382a and a potting dam 382b may be dispensed to provide respective seals to prevent unwanted flow of a potting material (e.g., potting material 372 shown in FIG. 8A). In this regard, the potting dam 382a and the potting dam 382b may be dispensed (e.g., in liquid form) as a hot melt material in a gap 383 at locations between the battery module 315 and the bar 380, or alternatively, between other regions of the battery pack 310 and the bar 380. Accordingly, as opposed to the potting dams 348 and 350 (shown in FIGS. 4 and 5, respectively) made from a solid (e.g., foam), the potting dams 382a and 382b may include a liquid-based, hot melt dispensed potting dam designed to cure to a solid. When the potting dams 382a and 382b cure and form a solid, a potting material may be disposed over the battery cells 320 at locations between the battery module 315 and the bar 380, or alternatively, between other regions of the battery pack 310 and the bar 380. However, the potting dams 382a and 382b may prevent a flow of the potting material to a location(s), e.g., a location(s) external to the battery module 315 and the bar 380.

Also, the battery pack 310 may further include a potting dam 382c and a potting dam 382d. Similar to the potting dams 382a and 382b, the potting dams 382c and 382d may be dispensed at locations between the battery module 315 and the bar 380, or alternatively, between other regions of the battery pack 310 and the bar 380. The potting dam 348 (shown in FIG. 8A), the potting dam 350 (shown in FIG. 9), and the potting dams 382a, 382b, 382c, and 382d may combine to confine the potting material 372 (shown in FIGS. 8A-9). In one or more implementations, one or more of the potting dams 348, 350, 382a, 382b, 382c, and 382d combine to confine the potting material 372 to a location between the battery cells 320.

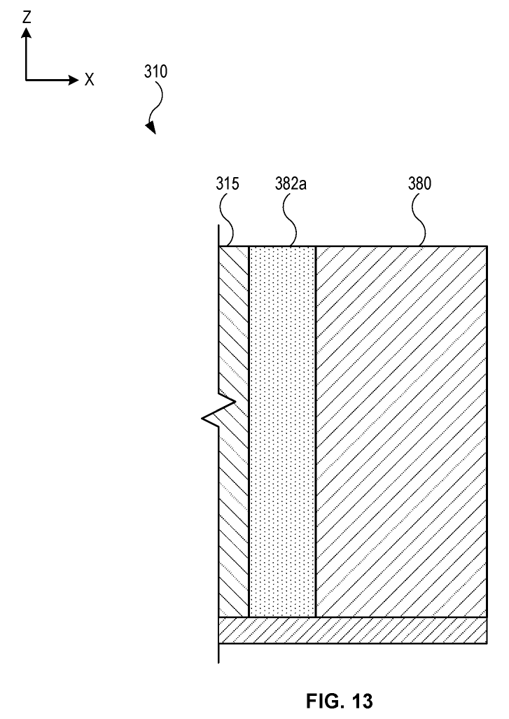

FIG. 13 illustrates a cross sectional view of the battery pack 310 shown in FIG. 12, further showing the potting dam 382a between the battery module 315 and the bar 380, in accordance with one or more implementations of the present disclosure. The potting dam 382a (representative of the potting dams 382b, 382c, and 382d shown in FIG. 12) may be dispensed and disposed vertically (e.g., primarily along the Z axis) to provide a vertical potting dam.

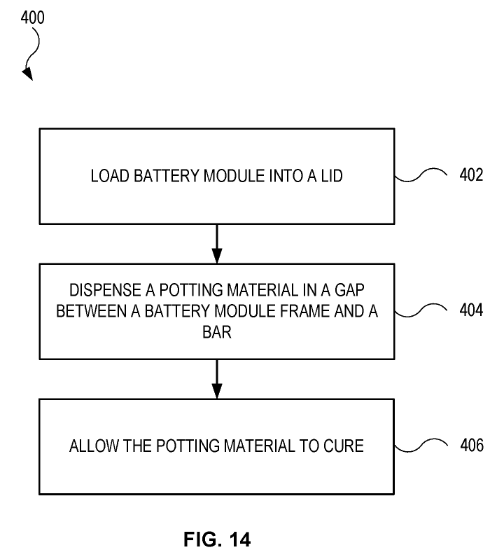

FIG. 14 illustrates a flow diagram showing a process 400 for providing a potting material to a battery pack, in accordance with implementations of the subject technology. For explanatory purposes, the process 400 is primarily described herein with reference to battery packs (e.g., battery pack 310 shown in FIG. 3). However, the process 400 is not limited to the battery pack 310 shown in FIG. 3, and one or more blocks (or operations) of the process 400 may be performed by one or more other components of other suitable moveable apparatuses, devices, or systems. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations. At block 402, a battery module (e.g., battery module 315 shown in FIG. 12) is loaded into a lid. Alternatively, a battery pack (e.g., battery pack 310) may be loaded into a lid. At block 404, a potting material is dispensed a gap between a battery module frame and a bar. The battery module frame may be part of the battery module. The bar make take the form of a longitudinal bar. Each corner of the battery module may include a gap between the module plastic frame and longitudinal member of the deep lid enclosure assembly. The temperature of the potting material is set such that the potting material viscosity allows the potting material to flow into irregular gaps and to fill the lower portion of this gap between other potting dams (e.g., foam potting dams such as the potting dams 348 and 350 shown in FIG. 3) and the bar. Also, if gap is insufficient, the dispense path may be run again to ensure fill coverage. At block 406, the potting material is allowed to cure. The potting material may harden within 30 seconds to form a seal. Additionally, after the potting material is cured, the assembly (e.g., battery pack and lid) may be rotated 180 degrees and installed in vehicle.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being "connected" or "coupled" to another element, it is to be understood that the elements can be directly connected to the other element, or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A potting dam, comprising:
a body comprising:
a first dimension configured to extend to at least a first end of a frame and to at least a second end of the frame opposite the first end, and
a second dimension less than the first dimension, wherein in response to a compression force, the body is configured to compress and provide a seal against a flow of a potting material in a direction along the second dimension.

2. The potting dam of claim 1, further comprising:
a first cut out portion configured to provide a first space for a first terminal; and
a second cut out portion configured to provide a second space for a first terminal.

3. The potting dam of claim 2, wherein based on the first cut out portion, the body is further configured to provide a seal against the flow of the potting material in a direction along the first dimension.

4. The potting dam of claim 2, wherein the body defines:
a first connection point to a cover configured to cover battery cells, the first connection point being external to the first cut out portion and the second cut out portion,
a second connection point to the cover, the second connection point being external to the first cut out portion and the second cut out portion, and
a third connection point to the cover, the third connection point being between the first cut out portion and the second cut out portion.

5. The potting dam of claim 1, wherein the first dimension is perpendicular with respect to the second dimension.

6. The potting dam of claim 1, wherein the body comprises a foam.

7. The potting dam of claim 6, wherein the foam comprises an open cell foam.

8. A battery pack, comprising:
a plurality of battery cells electrically coupled together via a current collector assembly;
a frame configured to cover at least a portion of the current collector assembly, the frame defining a lip;
a lid configured to receive at least the plurality of battery cells; and
a first potting dam, wherein in response to the first potting dam being compressed between the lip and the lid, the first potting dam is configured to compress and provide a seal to maintain a potting material between the plurality of battery cells.

9. The battery pack of claim 8, further comprising a cover configured to overlay the plurality of battery cells, wherein the first potting dam is coupled with the cover.

10. The battery pack of claim 9, further comprising a second potting dam, wherein:
the first potting dam is located at a first end of the cover, and
the second potting dam is located at a second end of the cover, the second end opposite the first end.

11. The battery pack of claim 10, wherein the second potting dam extends from the cover and is compressed between the lid and the lip.

12. The battery pack of claim 10, wherein the second potting dam comprises:
a first cut out portion configured to provide a first space for a first terminal; and
a second cut out portion configured to provide a second space for a first terminal.

13. The battery pack of claim 12, wherein the second potting dam defines:
a first connection point to the cover external to the first cut out portion and the second cut out portion,
a second connection point to the cover external to the first cut out portion and the second cut out portion, and
a third connection point to the cover between the first cut out portion and the second cut out portion.

14. The battery pack of claim 10, further comprising:
a bar that extends along the plurality of battery cells; and
a third potting dam comprising a hot melt material disposed in a gap between a module that carries the plurality of battery cells and the bar.

15. The battery pack of claim 14, wherein the first potting dam, the second potting dam, and the third potting dam combine to confine the potting material between the plurality of battery cells.

16. The battery pack of claim 10, wherein each of the first potting dam and the second potting dam comprise a foam.

17. A vehicle, comprising:
one or more electric motors;
a battery pack configured to provide power for the one or more electric motors, the battery pack comprising:
a plurality of battery cells electrically coupled together via a current collector assembly;
a frame configured to cover at least the current collector assembly, the frame defining a lip;
a cover configured to overlay the plurality of battery cells;
a lid configured to receive at least the plurality of battery cells;
a first potting dam coupled with a first end of the cover; and
a second potting dam coupled with a second end of the cover opposite the first end, wherein in response to the first potting dam and the second potting dam being compressed between the lip and the lid, the first potting dam and the second potting dam are configured to compress and provide respective seals to maintain a potting material between the plurality of battery cells.

18. The vehicle of claim 17, wherein the first potting dam extends from the cover.

19. The vehicle of claim 17, wherein the second potting dam comprises:
a first cut out portion configured to provide a first space for a first terminal; and
a second cut out portion configured to provide a second space for a first terminal.

20. The vehicle of claim 17, wherein the second potting dam defines:
a first connection point to the cover external to the first cut out portion and the second cut out portion,
a second connection point to the cover external to the first cut out portion and the second cut out portion, and
a third connection point to the cover between the first cut out portion and the second cut out portion.
